(19) United States
(12) Patent Application Publication
(10) Pub. No.: US 2012/0164589 A1
(43) Pub. Date: Jun. 28, 2012

(54) OPTICAL COMBUSTOR PROBE SYSTEM

(75) Inventors: Shawn Wehe, Niskayuna, NY (US); Joel Haynes, Schenectady, NY (US); Keith McManus, Clifton Park, NY (US); Gregory Knott, Katy, TX (US); Douglas L. Washburn, Cincinnati, OH (US)

(73) Assignee: GENERAL ELECTRIC COMPANY, Schnectady, NY (US)

(21) Appl. No.: 12/975,742

(22) Filed: Dec. 22, 2010

(51) Int. Cl. F23C 99/00; G01M 15/14

(52) U.S. Cl. 431/253; 73/112.01

(57) ABSTRACT

The present application provides an optical probe system for use with a combustion flame in a combustion chamber. The optical probe system may include a number of optical probes fixedly attached about the combustion chamber and positioned such that the optical probes collect light generated by the combustion flame in a field of view of each of the optical probes. One or more components external to the combustion chamber may produce and analyze signals indicative of the light generated by the combustion flame in the field of view of each of the optical probes.

### TECHNICAL FIELD

The present application relates generally to an optical combustor probe system and more particularly relates to an optical combustor probe system with a number of fiber optic probes positioned about a combustion chamber to detect flame holding and other types of combustion events.

### BACKGROUND OF THE INVENTION

Certain types of known gas turbine combustors use lean premixed combustion to reduce emissions of gases such as NOₓ (nitrogen oxides) and the like. Such combustors generally have a number of burners attached to a single combustion chamber. During operation, fuel is injected through a number of fuel injectors and mixes with a swirling airflow to produce a combustion flame. Because of the lean stoichiometry, lean premixed combustion may achieve lower flame temperatures and thus may produce lower emissions of NO gases and the like.

One facet of lean combustion environments is that the flame speed may increase with an increase in fuel concentration. Overall combustion zone aerodynamics thus may be designed to accommodate the lean flame speed. The fuel-air mixture approaching the combustion zone, however, may not always be homogenous. As a result of local variations in the fuel air mixture, the local flame speed may exceed combustion zone design limits. If conditions that support the elevated lean flame speed persist, the flame may encroach upon upstream structures and cause damage due to increased heat loads or otherwise.

There is thus a desire for improved combustor monitoring systems and methods such as optical combustor probe systems that may detect flame holding events and precursors thereof such that remedial action may be taken before damage occurs. Further, such an improved reaction time also may provide the ability to reduce operating margins to permit even leaner operations and, hence, lower emissions of NO gases and the like.

### SUMMARY OF THE INVENTION

The present application thus provides an optical probe system for use with a combustion flame in a combustion chamber. The optical probe system may include a number of optical probes fixedly attached about the combustion chamber and positioned such that the optical probes collect light generated by the combustion flame in a field of view of each of the optical probes. One or more components external to the combustion chamber may produce and analyze signals indicative of the light generated by the combustion flame in the field of view of each of the optical probes.

The present application further provides a method of monitoring a combustion flame in a combustion chamber. The method may include the steps of positioning a number of optical probes about the combustion chamber, generating a number of signals indicative of the combustion flame in a field of view of each of the optical probes, and analyzing the signals to determine a location of the combustion flame within the combustion chamber.

The present application further provides a combustor with a combustion flame therein. The combustor may include a combustion chamber and a number of optical probes fixedly attached about the combustion chamber. The optical probes may be positioned such that the optical probes collect light generated by the combustion flame in a field of view of each of the optical probes. A number of components external to the combustion chamber may produce and analyze signals indicative of the light generated by the combustion flame in the field of view of each of the optical probes.

These and other features and advantages of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a known gas turbine engine.

FIG. 2 is a partial side view of a combustor that may be used with the gas turbine engine of FIG. 1.

FIG. 3 is a schematic view of the optical combustor probe system as may be described herein.

FIG. 4 is a side plan view of a portion of an optical probe as may be described herein.

FIG. 5 is a partial side view of a known combustor with the optical combustor probe as may be described herein.

FIG. 6 is a front plan view of a combustor with a number of optical probes positioned thereon.

### DETAILED DESCRIPTION

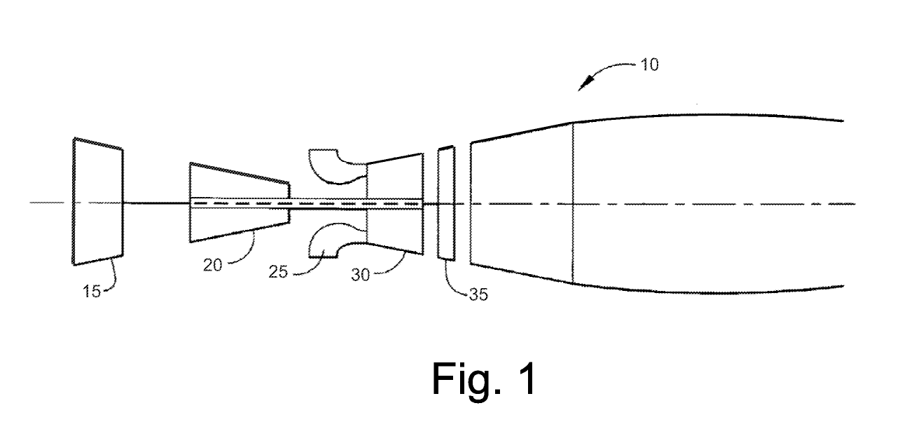

Referring now to the drawings, in which like numerals refer to like elements throughout the several views, FIG. 1 shows a schematic view of a gas turbine engine 10. The gas turbine engine 10 may include a low pressure compressor 15, a high pressure compressor 20, a combustor 25, a high pressure turbine 30, and a low pressure turbine 35. Air flows through the low pressure compressor 15 and compressed air is delivered to the high pressure compressor 20. The highly compressed air is then delivered to the combustor 25. The combustor 25 mixes the compressed flow of air with a compressed flow of fuel and ignites the mixture to create a flow of combustion gases. The flow of combustion gases is delivered in turn to the turbines 30, 35. The flow of combustion gases drives the turbines 30, 35 so as to produce mechanical work. Other types of gas turbine engines 10 and other configurations of components therein also are known.

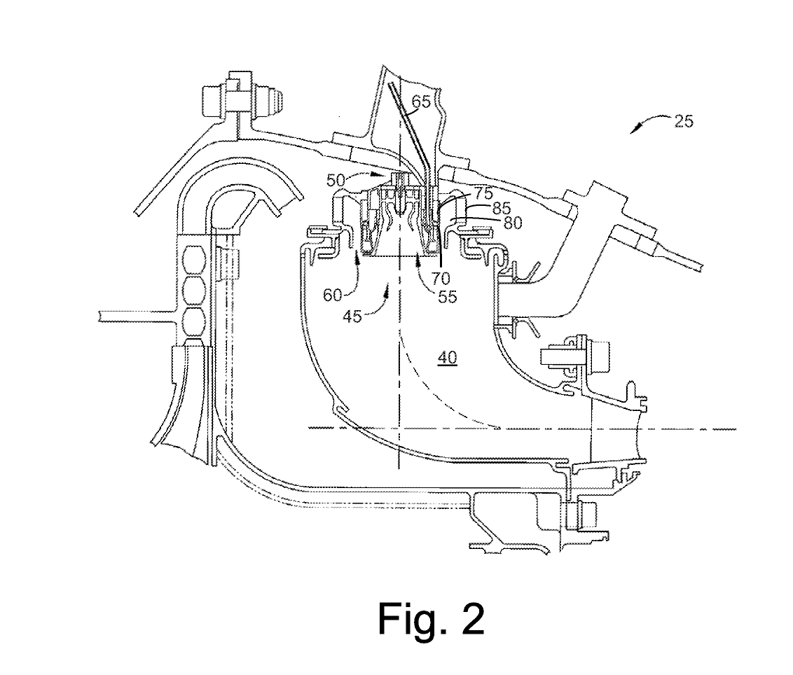

FIG. 2 is a partial side view of an example of the combustor 25 that may be used with the gas turbine engine 10 and the like. The combustor 25 includes a combustion zone or chamber 40 and an annular dome assembly 45 upstream of the combustion chamber 40. The annular dome assembly 45 may include a number of mixture assemblies 50 spaced circumferentially therein to deliver a mixture of fuel and air to the combustion chamber 40. Each mixture assembly 50 may include a pilot mixer 55 and a main mixer 60. A fuel manifold 65 may extend between the pilot mixer 55 and the main mixer 60. The fuel manifold 65 may lead to a number of injection ports 70 positioned about a main housing 75. A mixer cavity 80 may be defined between the main housing 75 and a cyclone 85. Other configurations and other components may be used herein. The combustor 25 described herein is for purposes of example only. Other types of combustors may be used herein. As described above, the combustor 25 mixes the flow of fuel and the flow of air to produce a combustion flame 90.

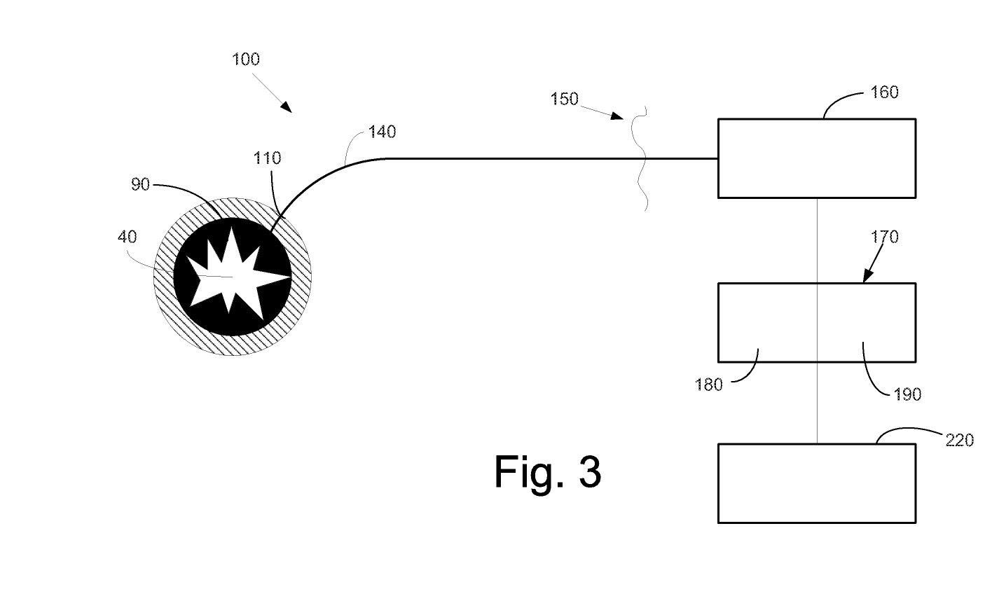

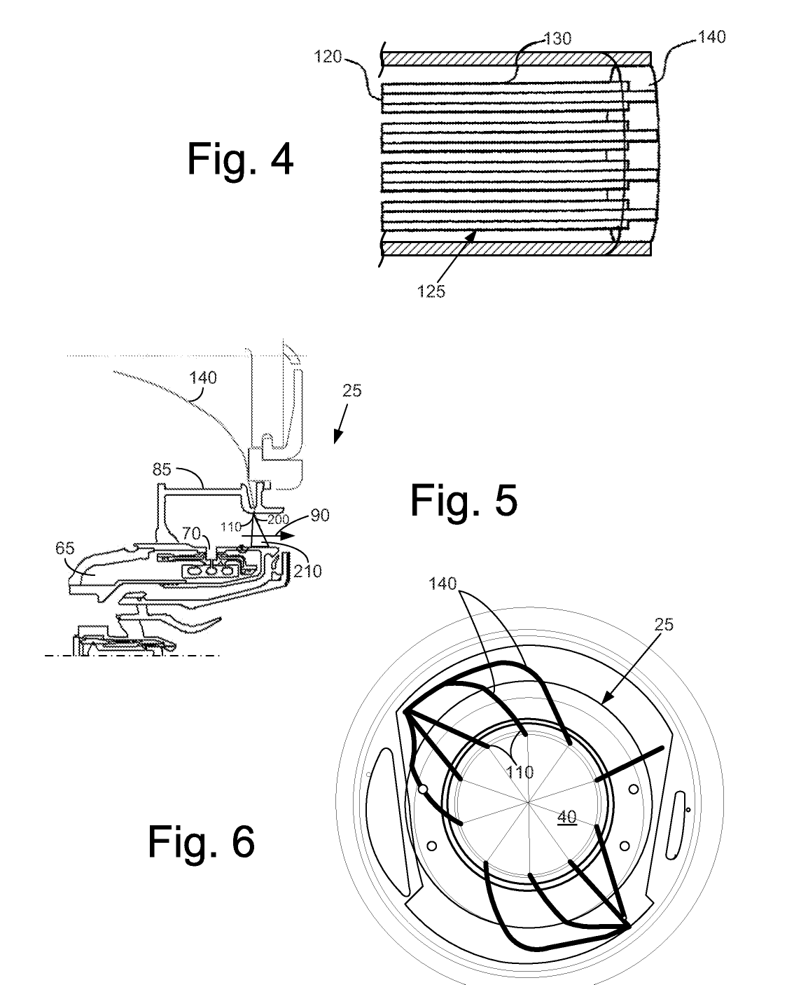

FIGS. 3 and 4 show an optical combustion probe system 100 as may be described herein. The optical combustor probe system 100 may include one or more optical combustor probes 110 positioned about the combustion chamber 40 of the combustor 25 or a similar type of device with the combustion flame 90 therein or other types of combustion dynamics. Any type of combustion and/or combustion chamber 40 may be used herein.

Each optical combustor probe 110 may include a bundle of optical fibers 120. The optical fibers 120 may be quartz fibers and the like. Other types of optical fibers 120 may be used herein. The optical fibers 120 preferably are relatively small diameter quartz fibers so as to enable a tighter bend radius as compared to a single large diameter fiber. Moreover, the small diameter quartz fibers may possess a similar light collection power. Any suitable optical fiber material may be used herein. A bundle 125 of the optical fibers 120 may be used.

The optical fibers 120 may have a coating 30 thereon. The coating 30 may be a gold coating or another type of precious metal. Similar coatings may be used herein so as to provide thermal protection. Other types of coatings resistant to high temperature also may be used herein. The optical fibers 120 may be positioned within a guide tube 140. The guide tube 140 may be made out of stainless steel or other types of temperature resistant materials. The optical combustor probes 110 with the optical fibers 120, the coatings 130, and the guide tube 140 thus may withstand the high operating temperatures and pressures within the combustion chamber 40 or otherwise. For example, the temperature and pressure within the combustion chamber 40 may exceed about 1400° Fahrenheit (about 760° Celsius) and about 750 pounds per square inch (gauge) (about 5200 kilopascals) or more.

The optical combustor probe system 100 further may includes a number of external components 150 positioned outside of the combustion chamber 40. The external components 150 may include a photo-detector module 160. The photo-detector module 160 contains optical components to separate spectrally the incoming collected light from the optical combustor probes 110. The photo-detector module 160 produces signals proportional to the intensity of the tight. The photo-detector module 160 generates output signals based upon the data received from the optical combustor probes 110 to a signal processing module 170. The signal processing module 170 analyzes the signals from the photo-detector module 160 to provide combustion information. Specifically, the signal processing module 170 may include a number of metal-can photomultiplier tubes 180 and the like. Because the photomultiplier tubes 180 have a fast response time, the photomultiplier tubes 180 may be used to monitor temporal variations within the combustion chamber 40. The signal processing module 170 also may include a spectrometer 190 and the like so as to capture the optical emission spectrum. The signal processor 170 thus processes both temporal frequency based upon the photomultiplier tubes 180 and the light frequency domains via the spectrometer 190. Interference filters also may be used herein. Other configurations and other types of components may be used herein.

FIG. 5 shows the use of one of the optical combustor probes 110 about the combustor 25. Specifically, an access hole 200 may be drilled about the cyclone 85 or about another position downstream of the injection ports 70. The guide tube 140 of the optical combustor probe 110 may be fed into the access hole 200 and may be welded to the cyclone 85 or other location. Given that the guide tube 140 may be made out of stainless steel, TIG (“Tungsten Inert Gas”) welding may be used. Other connection means may be used herein. The optical fibers 120 with the coating 130 thereon then may be threaded through the guide tube 140 and brazed to the access hole 200. Other connection means also may be used herein. The optical fibers 120 may be set at a desired field of view 210. Each optical combustor probe 110 thus may monitor the light generated by the combustion flame 90 or other types of combustion dynamics within its field of view 210.

As is shown in FIG. 6, the optical combustor probe system 100 may use any number of the optical combustor probes 110 positioned about the combustion chamber 40. The use of a number of the optical combustor probes 110 thus provides the ability to discriminate spatially the location of combustion events from different locations. In other words, the location and characteristics of the combustion flame 90 within the combustion chamber 40 may be accurately determined. Moreover, the use of the external components 150 provides the ability to determine remotely the nature of the combustions events.

In use, the optical combustor probes 110 of the optical combustor system 100 may be used to determine a combustion event by observing the “chemiluminescence” of the combustion flame 90 in a localized region of interest. Generally described, chemiluminescence is the optical radiation produced by combustion reactions. The combustion reactions produce molecules with high energy states. The excited molecules may transfer to lower energy states in part by emitting a light. The intensity of the emission may be proportional in part to the chemical production rate in a specific reaction. Chemiluminescense thus may measure reaction rates and heat release rates for information on the present strength of the combustion process in a specific region of view.

Specifically, signals indicative of the combustion flame 90 in the field of view 210 of each optical combustor probe 110 may be collected by the optical fibers 190 and guided to the photo-detector module 160. The photo-detector module 160 produces signals in proportional to the intensity of the light. The signals then may be analyzed in the signal processor 170 both temporally and based upon wavelength. The spectrometer 190 of the signal processor 170 may be configured to detect spectral radiation indicative of chemical emission effecting combustion stability. Further, spectral radiation indicative of fuel contaminants or impurities also may be detected. The photomultiplier tubes 180 of the signal processor 170 may measure temporal fluctuations. Other types of signal processing may be used herein. The signals provided by the photo-detector module 160 may be filtered to account for reflective background emissions cause by combustor geometry. By discriminating the signal levels from the background signals, combustion events in the regions of interest may be more accurately determined.

The optical combustor probe system 100 thus may be able to detect combustion events such a flame encroachment, flame holding, and the like with time constants of less than about 500 microseconds. Such a rapid response time generally permits an operator or a control system to take remedial action. Active feedback control thus may be provided herein. A feedback control system 220 may be in communication with the external components 150 and the control components of the compressor 25 and/or the gas turbine engine 10 in general.

In addition to the rapid response time, the use of the optical combustor probe system 100 actively prevents undesirable combustion events such that overall operating margins may be reduced Reducing overall operating margins may permit a leaner operation and hence greater operating efficiency with fewer emissions. Reducing operating margins also may lead to more compact geometries that may be lighter in overall weight. Moreover, undesirable combustion events now may be recorded and logged so as to provide improved prediction capability on product life and maintenance requirements.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. An optical probe system for use with a combustion flame in a combustion chamber, comprising:
a plurality of optical probes fixedly attached about the combustion chamber;
wherein the plurality of optical probes are positioned such that the plurality of optical probes collects light generated by the combustion flame in a field of view of each of the plurality of optical probes; and
one or more components external to the combustion chamber to produce and analyze signals indicative of the light generated by the combustion flame in the field of view of each of the plurality of optical probes.

2. The optical probe system of claim 1, wherein the plurality of optical probes comprises a plurality of coated optical fibers.

3. The optical probe system of claim 1, wherein the plurality of optical probes comprises a bundle of optical fibers.

4. The optical probe system of claim 1, wherein the plurality of optical probes comprises a plurality of optical fibers positioned within a stainless steel guide tube.

5. The optical probe system of claim 1, wherein the one or more components external to the combustion chamber comprise a photo-detector module to produce the signals indicative of the light generated by the combustion flame in the field of view of each of the plurality of optical probes.

6. The optical probe system of claim 1, wherein the one or more components external to the combustion chamber comprise a signal processing module to analyze the signals indicative of the light generated by the combustion flame in the field of view of each of the plurality of optical probes.

7. The optical probe system of claim 6, wherein the signal processing module comprises a plurality of photomultiplier tubes.

8. The optical probe system of claim 6, wherein the signal processing module comprises a spectrometer.

9. The optical probe system of claim 1, wherein the one or more components external to the combustion chamber are in communication with a feedback control system and wherein the feedback control system is associated with the combustion chamber.

10. A method of monitoring a combustion flame in a combustion chamber, comprising:
positioning a plurality of optical probes about the combustion chamber;
generating a plurality of signals indicative of the combustion flame in a field of view of each of the plurality of optical probes; and
analyzing the plurality of signals to determine a location of the combustion flame within the combustion chamber.

11. The method of monitoring a combustion flame of claim 10, wherein the analyzing step comprises analyzing the combustion flame temporally.

12. The method of monitoring a combustion flame of claim 10, wherein the analyzing step comprises analyzing the combustion flame based upon wavelength.

13. The method of monitoring a combustion flame of claim 10, wherein the generating step and the analyzing step are performed externally to the combustion chamber.

14. The method of monitoring a combustion flame of claim 10, further comprising the step of communicating with a feedback control system associated with the combustion chamber.

15. A combustor with a combustion flame therein, comprising:
a combustion chamber; and
a plurality of optical probes fixedly attached about the combustion chamber;
wherein the plurality of optical probes are positioned such that the plurality of optical probes collects light generated by the combustion flame in a field of view of each of the plurality of optical probes; and
a plurality of components external to the combustion chamber to produce and analyze signals indicative of the light generated by the combustion flame in the field of view of each of the plurality of optical probes.

16. The combustor of claim 15, wherein the plurality of optical probes comprises a plurality of coated optical fibers.

17. The combustor of claim 15, wherein the plurality of components external to the combustion chamber comprises a photo-detector module to produce the signals indicative of the light generated by the combustion flame in the field of view of each of the plurality of optical probes.

18. The combustor of claim 15, wherein the plurality of components external to the combustion chamber comprises a signal processing module to analyze the signals indicative of the light generated by the combustion flame in the field of view of each of the plurality of optical probes.

19. The combustor of claim 18, wherein the signal processing module comprises a plurality of photomultiplier tubes.

20. The combustor of claim 18, wherein the signal processing module comprises a spectrometer.
